(19) United States
(12) Patent Application Publication
(10) Pub. No.: US 2017/0124765 A1
(43) Pub. Date: May 4, 2017

(54) CONTROL METHOD AND INFORMATION PROCESSING SYSTEM

(71) Applicant: FUJITSU LIMITED, Kawasaki-shi (JP)

(72) Inventor: Kyosuke Imamura, Kokubunji (JP)

(73) Assignee: FUJITSU LIMITED, Kawasaki-shi (JP)

(21) Appl. No.: 15/333,429

(22) Filed: Oct. 25, 2016

(30) Foreign Application Priority Data
Oct. 28, 2015 (JP) 2015-212125

(51) Int. Cl. G06T 19/00; G06T 7/00

(52) U.S. Cl. CPC G06T 19/006; G06T 7/0042; G06T 2207/30208

(57) ABSTRACT

A system includes circuitry configured to acquire a first image, extract a plurality of candidate areas each including an object having a shape corresponding to a shape of a marker to be used for augmented reality, control a display to display a first composite image that applies a predetermined graphical effect on the candidate areas in the first image, receive selection of a first area from among the candidate areas, acquire identification information corresponding to a first marker included in the first area from a source other than the first image, receive an input corresponding to a first position on the first image as an arrangement position of content to be virtually arranged with reference to the first marker, convert the first position into positional information in a coordinate system corresponding to the first area, and store the positional information, the identification information, and the content.

### CROSS-REFERENCE TO RELATED APPLICATION

This application is based upon and claims the benefit of priority of the prior Japanese Patent Application No. 2015-212125, filed on Oct. 28, 2015, the entire contents of which are incorporated herein by reference.

### FIELD

The embodiments discussed herein are related to augmented reality.

### BACKGROUND

In recent years, there has been performed display of contents, which is called augmented reality (hereinafter, called AR) and in which, by using a smartphone or the like incorporating a camera, markers installed in articles are image-captured, thereby displaying the contents on a captured image screen. In addition, in authoring in which an AR content is associated with an AR marker serving as a marker installed in an article, inputting of the AR content is performed in a state in which the AR marker is image-captured.

Related technologies are disclosed in, for example, Japanese Laid-open Patent Publication No. 2015-001875, Japanese Laid-open Patent Publication No. 2013-004001, and International Publication Pamphlet No. WO 2012/105175.

### SUMMARY

According to an aspect of the invention, an information processing system includes circuitry configured to acquire a first image captured by an imaging device, extract, from the first image, a plurality of candidate areas each including an object having a shape corresponding to a shape of a marker to be used for augmented reality, control a display to display a first composite image that applies a predetermined graphical effect on the candidate areas in the first image, receive selection of a first area of the candidate areas from among the candidate areas, acquire identification information corresponding to a first marker included in the first area from a source other than the first image, receive an input corresponding to a first position on the first image as an arrangement position of content to be virtually arranged with reference to the first marker, convert the first position into positional information in a coordinate system corresponding to the first area, and store, in a memory, the positional information, the identification information, and the content in association with one another.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an information processing device of a first embodiment;

FIG. 2 is a diagram illustrating an example of a content storage unit;

FIG. 3 is a diagram illustrating an example of a positional relationship;

FIG. 4 is a diagram illustrating another example of the positional relationship;

FIG. 5 is a diagram illustrating an example of extraction of AR marker candidates;

FIG. 6 is a diagram illustrating an example of a captured image screen at a time of editing;

FIG. 7 is a diagram illustrating another example of a captured image screen at a time of editing;

FIG. 8 is a diagram illustrating an example of a captured image screen at a time of display;

FIG. 9 is a diagram illustrating another example of a captured image screen at a time of display;

FIG. 10 is a flowchart illustrating an example of display control processing of the first embodiment;

FIG. 11 is a flowchart illustrating an example of content display processing;

FIG. 12 is a block diagram illustrating an example of a configuration of an information processing device of a second embodiment;

FIG. 13 is a flowchart illustrating an example of display control processing of the second embodiment;

FIG. 14 is a block diagram illustrating an example of a configuration of an information processing device of a third embodiment;

FIG. 15 is a flowchart illustrating an example of display control processing of the third embodiment; and

FIG. 16 is a diagram illustrating an example of a computer to execute a display control program.

### DESCRIPTION OF EMBODIMENTS

Since an angle of view of a camera is narrow in a case where authoring is performed by using a terminal such as a smartphone, a range of AR contents able to be edited at one time becomes narrow. On the other hand, in a state in which all AR contents come within the angle of view, it becomes difficult to recognize an AR marker. Therefore, in a case where AR contents are arranged for the same AR marker over a wide range, it is difficult to simultaneously arrange or operate all the AR contents.

In one aspect, an object of the technology disclosed in embodiments is to set AR contents even at a distance at which it is difficult to recognize an AR marker.

Hereinafter, examples of a display control method, a display control program, and an information processing device, disclosed by the present application, will be described in detail, based on drawing. Note that the present embodiments do not limit the disclosed technology. In addition, the following embodiments may be arbitrarily combined to the extent that these do not contradict.

### First Embodiment

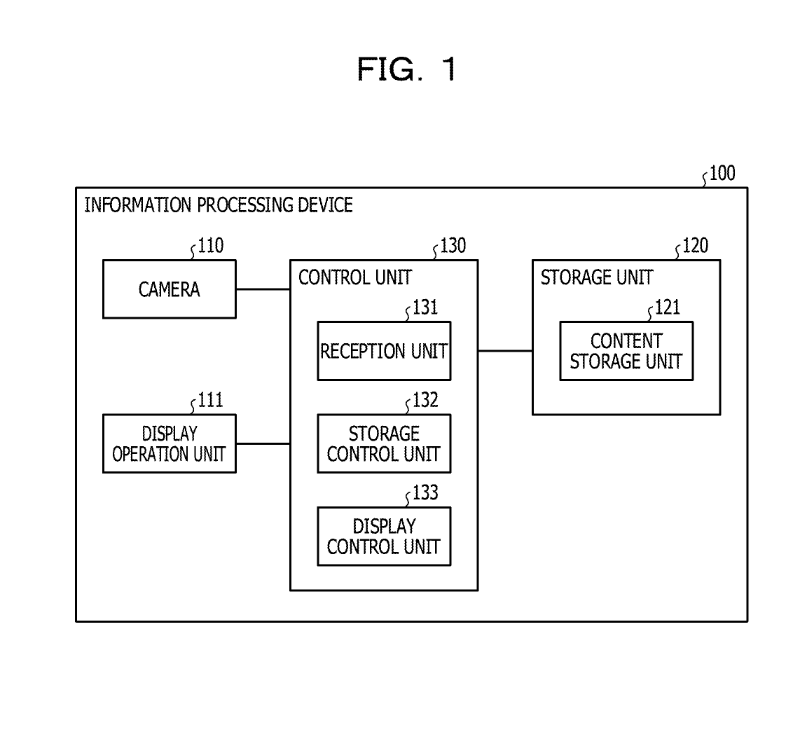

FIG. 1 is a block diagram illustrating an example of a configuration of an information processing device of a first embodiment. An information processing device 100 illustrated in FIG. 1 extracts a predetermined shape from an acquired captured image and receives inputting of identification information and specification of a position on a captured image screen. The information processing device 100 causes the storage unit 120 to store therein a positional relationship between an extraction position of the predetermined shape and the specified position while associating the positional relationship with the input identification information. Upon extracting, based on an AR marker having a predetermined shape, identification information, the information processing device 100 displays an AR content corresponding to the identification information, in accordance with a positional relationship stored in the storage unit 120. From this, the information processing device 100 is able to set the AR content even at a distance at which it is difficult to recognize the AR marker.

As illustrated in FIG. 1, the information processing device 100 includes a camera 110, a display operation unit 111, a storage unit 120, and a control unit 130. Note that in addition to the functional units illustrated in FIG. 1, the information processing device 100 may include various kinds of functional units included in a known computer, for example, functional units such as a communication unit, various kinds of input devices, and a sound-output device. As examples of the information processing device 100, various kinds of terminals such as a tablet terminal, a smartphone, and a mobile phone may be adopted.

The camera 110 image-captures an object assigned with an AR marker or an AR marker candidate. The camera 110 uses, as an imaging element, for example, a complementary metal oxide semiconductor (CMOS) image sensor, a charge coupled device (CCD) image sensor, or the like, thereby image-capturing an image. The camera 110 subjects light received by the imaging element to photoelectric conversion and performs analog-digital (A-D) conversion, thereby generating a captured image. The camera 110 outputs the generated captured image to the control unit 130. In addition, if the control unit 130 inputs a stop signal, the camera 110 stops outputting of a captured image, and if a start signal is input, the camera 110 starts outputting of a captured image. In other words, if, for example, the start signal is input, the camera 110 outputs a captured image as a moving image, and if the stop signal is input, the camera 110 stops outputting of the moving image.

Note that as an AR marker to be image-captured, a marker, which stores information by dividing, into areas, an area within, for example, a black border of a white square shape having the black border and paining the individual areas in white and black, may be used. In addition, regarding the AR marker, while not being able to be recognized as an AR marker on a captured image, a quadrangle area seems to be an AR marker in some cases. In this case, the relevant area is defined as an AR marker candidate. Furthermore, AR marker candidates include an area that is close to a square shape and that seems to be an AR marker while not being an AR marker.

The display operation unit 111 corresponds to a display device for displaying various kinds of information and an input device to receive various kinds of operations from a user. As the display device, the display operation unit 111 is realized by, for example, a liquid crystal display or the like. In addition, as the input device, the display operation unit 111 is realized by, for example, a touch panel or the like. In other words, in the display operation unit 111, the display device and the input device are integrated. The display operation unit 111 outputs, as operation information to the control unit 130, an operation input by the user.

The storage unit 120 is realized by, for example, a semiconductor memory element such as a random access memory (RAM) or a flash memory or a storage device such as a hard disk or an optical disk. The storage unit 120 includes a content storage unit 121. In addition, the storage unit 120 stores therein information used for processing in the control unit 130.

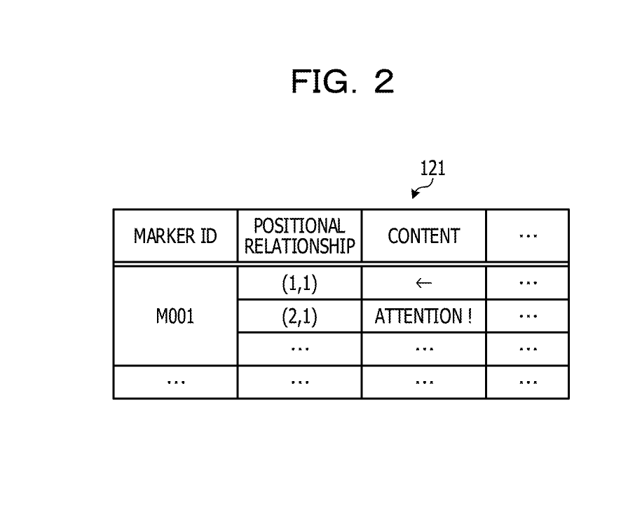

The content storage unit 121 stores therein AR contents while associating the AR contents with marker IDs (Identifiers) of respective AR markers. FIG. 2 is a diagram illustrating an example of a content storage unit. As illustrated in FIG. 2, the content storage unit 121 includes items such as a “marker ID”, a “positional relationship”, and a “content”. The content storage unit 121 stores therein marker IDs while associating each one of the marker IDs with, for example, groups of positional relationships and contents.

The “marker ID” is an identifier to identify an AR marker. The “positional relationship” is information indicating a relative position between an AR content and an AR marker. The “positional relationship” is able to be expressed by coordinates with, for example, a side of an AR marker as a reference value. The “content” is an AR content to be displayed in accordance with an AR marker. As the “content”, for example, an arrow “←” indicating a check point, a character string “attention!” for calling attention, an image, a 3D content, a moving image, and so forth may be used. In an example of the first row of FIG. 2, a content “←” and so forth to be displayed at a position of coordinates (1,1) are associated with a marker ID “M001”. Note that the coordinates are expressed by, for example, 3 axes of x, y, and z and the z-axis may be omitted in a case where the z-axis is “0”.

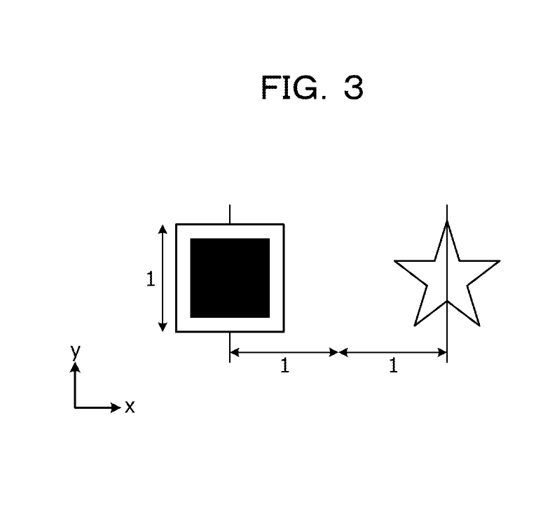

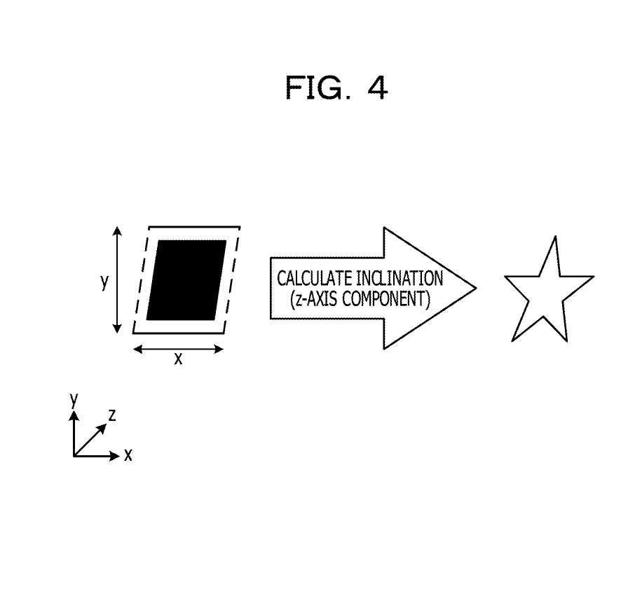

Here, by using FIG. 3 and FIG. 4, a positional relationship between an AR marker and an AR content will be described. FIG. 3 is a diagram illustrating an example of a positional relationship. In the example of FIG. 3, a star serving as an AR content corresponds to a case of being located at “2” from the center of an AR marker in an x-axis direction and being located at “0” from the center of the AR marker in a y-axis direction, in other words, being located at coordinates (2,0) while a side of the AR marker is defined as “1”.

FIG. 4 is a diagram illustrating another example of the positional relationship. FIG. 4 is an example of display of an AR content in an image obtained by image-capturing an oblique lateral view of the AR marker. In the example of FIG. 4, a value of the z-axis is calculated based on a ratio between a length of the x-axis of the AR marker and a length of the y-axis thereof, and the position of the star serving as the AR content is expressed based on the coordinates (x,y,z). In addition, in the example of FIG. 4, the magnitude and direction of inclination, in other words, the positive or negative of the z-axis is calculated in accordance with ratios of facing sides of the AR marker.

Returning to the description of FIG. 1, by using a RAM as a working area, a program stored in an internal storage device is executed by, for example, a central processing unit (CPU), a micro processing unit (MPU), or the like, thereby realizing the control unit 130. In addition, the control unit 130 may be realized by, for example, an integrated circuit such as an application specific integrated circuit (ASIC) or a field programmable gate array (FPGA). The control unit 130 includes a reception unit 131, a storage control unit 132, and a display control unit 133 and realizes or performs functions and operations of information processing to be described later. Note that an inner structure of the control unit 130 is not limited to the configuration illustrated in FIG. 1 and may adopt another configuration if the other configuration performs the information processing to be described later. In addition, the control unit 130 causes the display operation unit 111 to display a captured image input by the camera 110.

If the display operation unit 111 inputs operation information to the effect that authoring is to be initiated, the reception unit 131 acquires a captured image from the camera 110 and outputs the stop signal to the camera 110. At this time, the reception unit 131 causes the display operation unit 111 to display the acquired captured image. The reception unit 131 scans the acquired captured image and determines whether or not one or more AR marker candidates exist. In a case where no AR marker candidate exists, the reception unit 131 outputs the start signal to the camera 110.

In a case where one or more AR marker candidate exists, the reception unit 131 extracts shapes of the respective AR marker candidates from the captured image. In other words, the reception unit 131 extracts predetermined shapes from the acquired captured image. The reception unit 131 causes the AR marker candidates, from which shapes thereof on the captured image are extracted, to be highlighted. Here, each of the predetermined shapes only has to be a shape from which the size and inclination of the relevant shape are able to be measured or calculated.

On the captured image caused to be displayed by the display operation unit 111, the reception unit 131 starts receiving selection for the AR marker candidates. The reception unit 131 determines whether or not selection is received. In a case where no selection is received, the reception unit 131 waits for reception of selection. In a case where selection is received, the reception unit 131 starts receiving a marker ID.

The reception unit 131 determines whether or not a marker ID is received. In a case where no marker ID is received, the reception unit 131 waits for reception of a marker ID. In a case where a marker ID is received, the reception unit 131 associates the received marker ID with the AR marker candidate for which the selection is received and implements authoring of a AR content corresponding to the relevant AR marker candidate.

The reception unit 131 receives the marker ID, based on, for example, inputting to the display operation unit 111, performed by a user. In addition, the reception unit 131 may receive, for example, identification information, in other words, a marker ID, extracted by recognizing an AR marker immediately before this scanning of the captured image. Furthermore, the reception unit 131 may implement the authoring in a state in which the user comes close to AR marker candidates once and moves away therefrom after causing the AR marker to be recognized and a wide angle of view is secured.

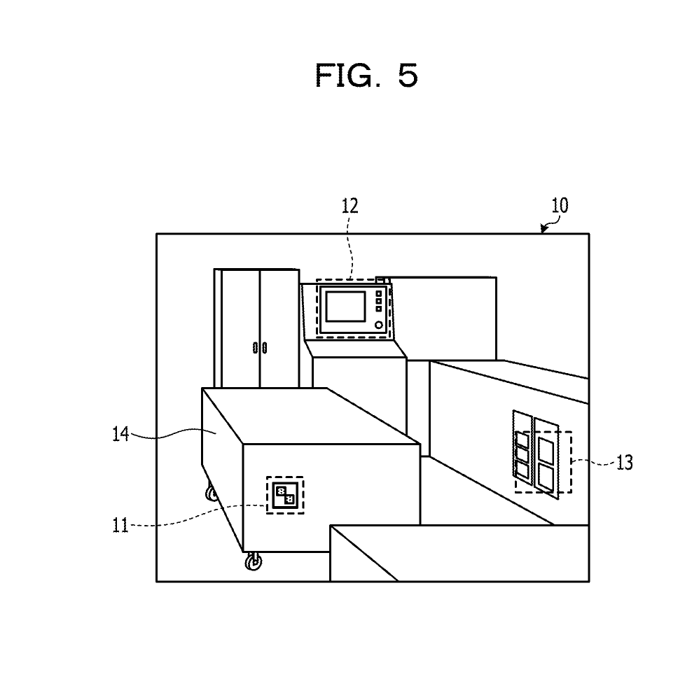

Here, extraction of AR marker candidates will be described by using FIG. 5. FIG. 5 is a diagram illustrating an example of extraction of AR marker candidates. As illustrated in FIG. 5, in a captured image screen 10, areas 11 to 13 are extracted as AR marker candidates. In the captured image screen 10, the user performs selection on the AR marker candidates of the areas 11 to 13. In the example of FIG. 5, an AR marker candidate of the area 11 installed in an article 14 is selected. Note that while not being an AR marker, each of AR marker candidates of the areas 12 and 13 is an area that seems to be an AR marker.

As the authoring, first the reception unit 131 receives a position on the captured image, at which an AR content is to be arranged. Regarding, for example, specification of a position, the reception unit 131 receives specification of a position with a side of an AR marker as a reference value. The reception unit 131 outputs, to the storage control unit 132, the received position on the captured image, at which the AR content is to be arranged, while associating, with the marker ID, the received position on the captured image, at which the AR content to be arranged. In other words, the reception unit 131 outputs, to the storage control unit 132, the position on the captured image, at which the AR content is to be arranged, while associating, with the marker ID received for the corresponding AR marker candidate, the position on the captured image, at which the AR content to be arranged. In addition, in a case where AR contents are to be arranged, the reception unit 131 outputs, to the storage control unit 132, positions of the AR contents and the marker ID while associating the positions of the respective AR contents with the marker ID. Furthermore, the reception unit 131 outputs, to the storage control unit 132, the position of the AR marker candidate for which the selection is received and the input AR contents.

If the reception unit 131 inputs the position of the corresponding AR marker candidate, the marker ID, and the positions of the AR contents, the storage control unit 132 stores, in the content storage unit 121, a positional relationship between the position of the corresponding AR marker candidate and the positions of the AR contents while associating the positional relationship with the marker ID. In addition, the storage control unit 132 stores, in the content storage unit 121, the AR contents while associating the AR contents with the marker ID. In other words, the storage control unit 132 stores an authoring result in the content storage unit 121. Here, the positional relationship may be expressed by relative coordinates in which the position of, for example, the corresponding AR marker candidate serve as a reference. If storing of the authoring result is completed, the storage control unit 132 outputs the start signal to the camera 110.

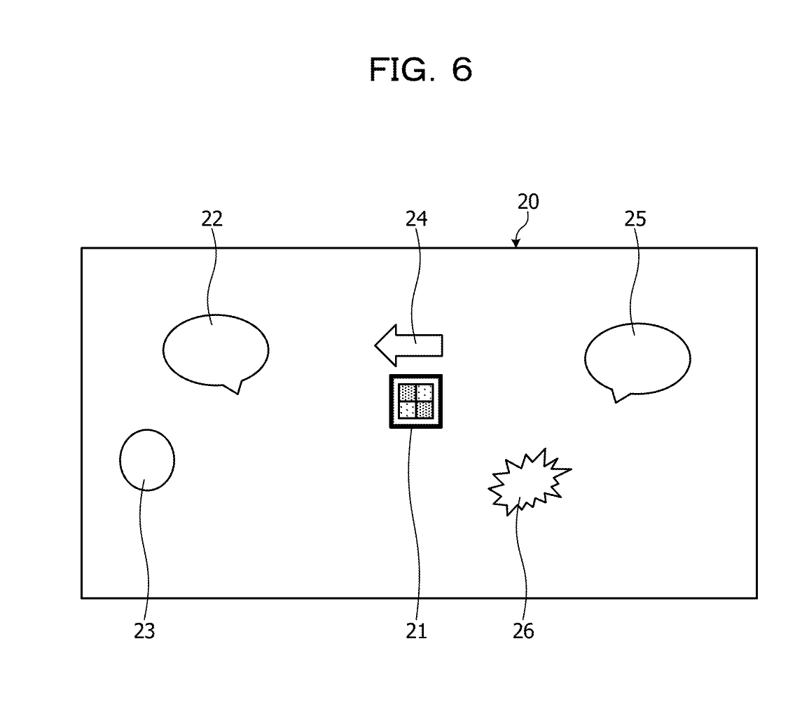

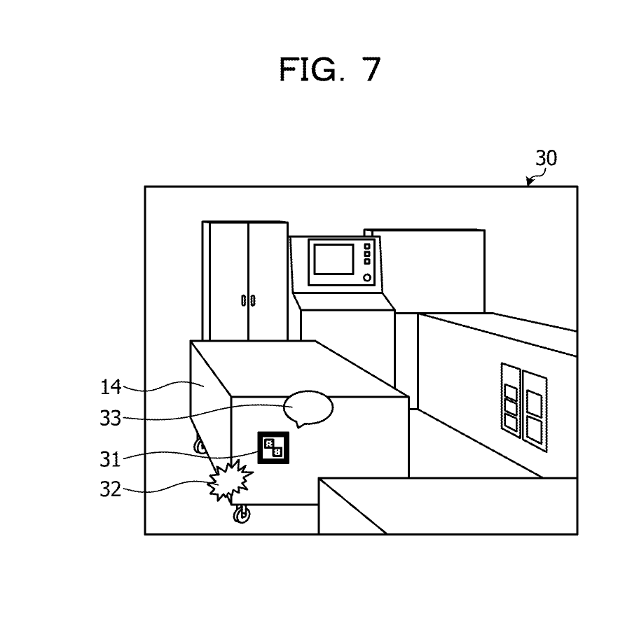

Here, by using FIG. 6 and FIG. 7, the authoring, in other words, editing of AR contents will be described. FIG. 6 is a diagram illustrating an example of a captured image screen at a time of editing. As illustrated in FIG. 6, an AR marker candidate 21 is displayed in a captured image screen 20 at a time of editing. In the captured image screen 20, first, a user selects an AR marker candidate 21 and inputs a marker ID. In the captured image screen 20, next, the user inputs AR contents 22 to 26. At this time, the captured image screen 20 corresponds to an image image-captured from a distance at which it is difficult to recognize the AR marker candidate 21 as an AR marker.

FIG. 7 is a diagram illustrating another example of a captured image screen at a time of editing. FIG. 7 is a captured image screen at a time of editing in a case where the AR marker candidate of the area 11 is selected in the example of FIG. 5. As illustrated in FIG. 7, in a captured image screen 30, a user selects an AR marker candidate 31 installed in the article 14 and inputs a marker ID. In the captured image screen 30, next, the user inputs AR contents 32 and 33. In the same way as the captured image screen 20 in FIG. 6, the captured image screen 30 at this time corresponds to an image image-captured from a distance at which it is difficult to recognize the AR marker candidate 31 as an AR marker.

Returning to the description of FIG. 1, upon recognizing an AR marker within a captured image in a case where the display operation unit 111 displays the captured image input by the camera 110, the display control unit 133 extracts identification information, in other words, a marker ID, based on the recognized AR marker. Upon extracting the marker ID, the display control unit 133 references the content storage unit 121 and causes an AR content corresponding to the marker ID to be displayed on the captured image screen, based on a positional relationship.

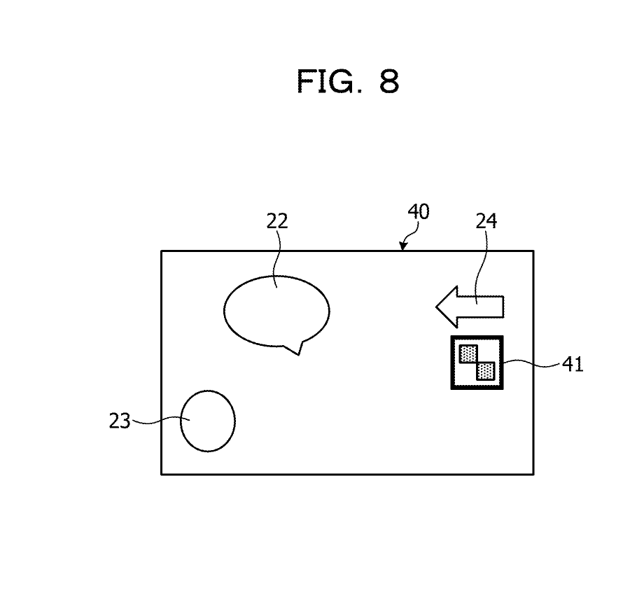

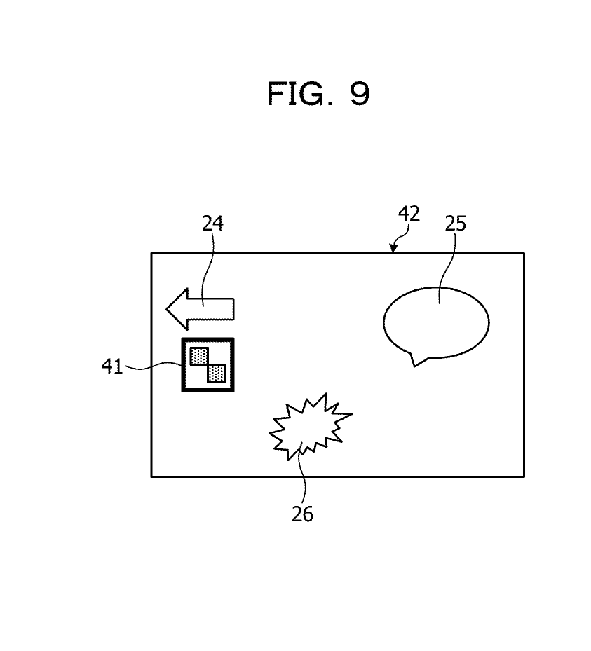

Here, by using FIG. 8 and FIG. 9, a captured image screen at a time of display of an AR content will be described. FIG. 8 is a diagram illustrating an example of a captured image screen at a time of display. As illustrated in FIG. 8, in a captured image screen 40, if an AR marker 41 is recognized, the AR contents 22 to 24 associated with the marker ID of the AR marker 41 are displayed. Here, the marker ID of the AR marker 41 is the same as the marker ID of the AR marker candidate 21 in FIG. 6. In the captured image screen 40, the AR marker 41 is located on a right side on the captured image screen, and the AR contents 22 to 24 located on the left side and the upper side of the AR marker 41 are displayed. In other words, in the captured image screen 40, since the user comes closer to the AR marker 41 than in the captured image screen 20 in FIG. 6, it is possible to recognize the AR marker 41. However, since the angle of view is narrow, a state in which it is difficult to display all the AR contents set in the captured image screen 20 in FIG. 6 is produced.

Next, it is assumed that the user moves the information processing device 100 so that the AR marker 41 moves from the right side on the captured image screen and is located on a left side thereon, compared with the state of FIG. 8. A captured image screen in this case is illustrated in FIG. 9. FIG. 9 is a diagram illustrating another example of a captured image screen at a time of display. In a captured image screen 42 in FIG. 9, the AR marker 41 is located on a left side on the captured image screen, and the AR contents 24 to 26 located on the right side and the upper side of the AR marker 41 are displayed.

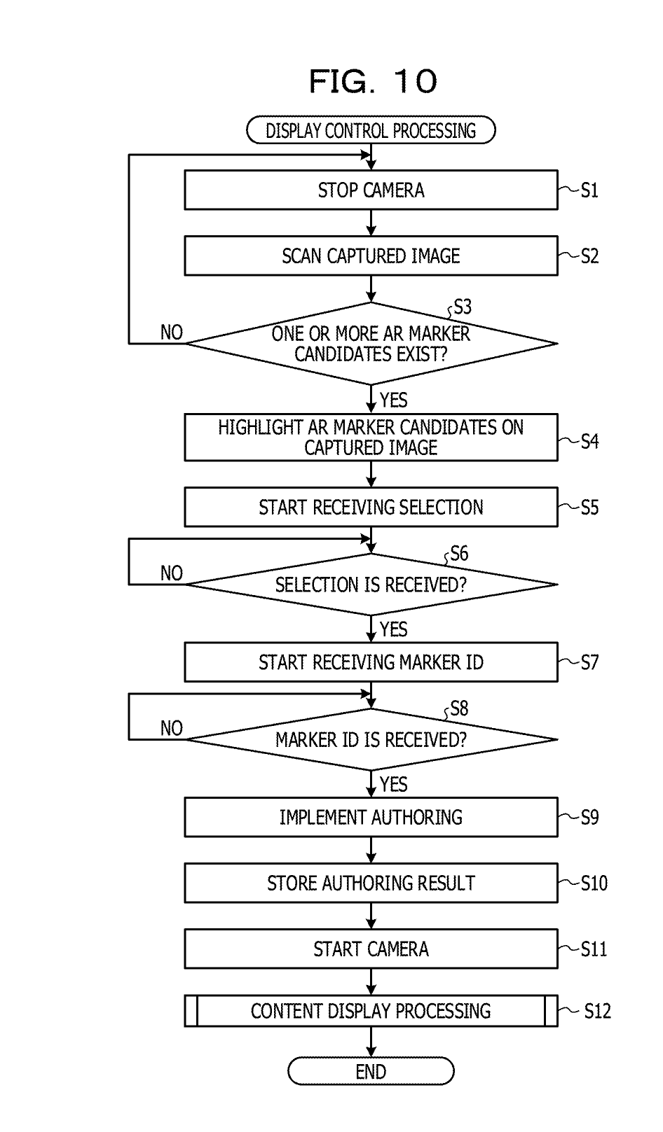

Next, an operation of the information processing device 100 of the first embodiment will be described. FIG. 10 is a flowchart illustrating an example of display control processing of the first embodiment.

The control unit 130 outputs the start signal to the camera 110. The control unit 130 causes the display operation unit 111 to display a captured image input by the camera 110. If the display operation unit 111 inputs operation information to the effect that authoring is to be initiated, the reception unit 131 acquires a captured image from the camera 110 and outputs the stop signal to the camera 110. If the stop signal is input by the control unit 130, the camera 110 stops outputting of a captured image (step S1).

The reception unit 131 scans the acquired captured image (step S2) and determines whether or not one or more AR marker candidates exist (step S3). In a case where no AR marker candidate exists (step S3: negative), the reception unit 131 outputs the start signal to the camera 110 and returns to step S1.

In a case where one or more AR marker candidates exist (step S3: affirmative), the reception unit 131 extracts shapes of the respective AR marker candidates from the captured image. The reception unit 131 causes the AR marker candidates, from which shapes thereof on the captured image are extracted, to be highlighted (step S4). On the captured image caused to be displayed by the display operation unit 111, the reception unit 131 starts receiving selection for the AR marker candidates (step S5). The reception unit 131 determines whether or not selection is received (step S6). In a case where no selection is received (step S6: negative), the reception unit 131 repeats the determination in step S6.

In a case where selection is received (step S6: affirmative), the reception unit 131 starts receiving a marker ID (step S7). The reception unit 131 determines whether or not a marker ID is received (step S8). In a case where no marker ID is received (step S8: negative), the reception unit 131 repeats the determination in step S8.

In a case where a marker ID is received (step S8: affirmative), the reception unit 131 associates the received marker ID with the AR marker candidate for which the selection is received and implements authoring of a AR content corresponding to the relevant AR marker candidate (step S9). As the authoring, first the reception unit 131 receives a position on the captured image, at which the AR content is to be arranged. The reception unit 131 outputs, to the storage control unit 132, the position on the captured image, at which the AR content is to be arranged, while associating, with a marker ID received for the AR marker candidate, the position on the captured image, at which the AR content to be arranged. In addition, the reception unit 131 outputs, to the storage control unit 132, the position of the AR marker candidate for which the selection is received and the input AR content.

If the reception unit 131 inputs the position of the corresponding AR marker candidate, the marker ID, and the position of the AR content, the storage control unit 132 stores, in the content storage unit 121, a positional relationship between the position of the AR marker candidate and the position of the AR content while associating the positional relationship with the marker ID. In addition, the storage control unit 132 stores, in the content storage unit 121, the AR content while associating the AR content with the marker ID. In other words, the storage control unit 132 stores an authoring result in the content storage unit 121 (step S10). If storing of the authoring result is completed, the storage control unit 132 outputs the start signal to the camera 110. If the start signal is input, the camera 110 starts outputting of a captured image (step S11).

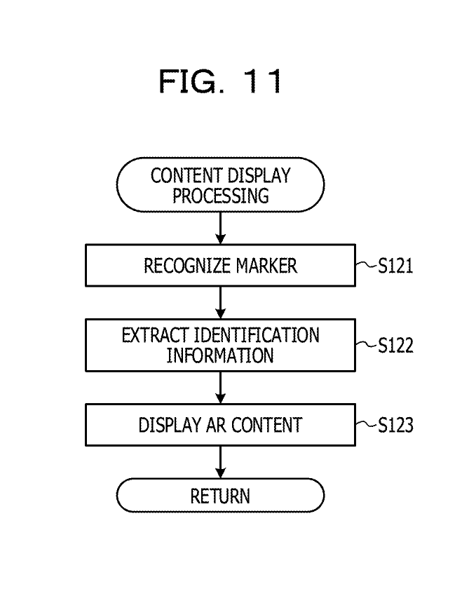

Upon recognizing an AR marker within the captured image in a case where the display operation unit 111 displays the captured image input by the camera 110, the display control unit 133 performs content display processing (step S12). Here, the content display processing will be described by using FIG. 11. FIG. 11 is a flowchart illustrating an example of the content display processing.

The display control unit 133 recognizes an AR marker on a captured image (step S121) and extracts identification information, based on the recognized AR marker (step S122). Upon extracting identification information, in other words, a marker ID, the display control unit 133 references the content storage unit 121 and causes an AR content corresponding to the marker ID to be displayed on a captured image screen (step S123) and returns to former processing. From this, the display control unit 133 is able to display the AR content corresponding to the AR marker.

Returning to the description of the display control processing in FIG. 10, if the content display processing finishes, the display control unit 133 terminates the display control processing. From this, the information processing device 100 is able to set the AR content even at a distance at which it is difficult to recognize the AR marker. In other words, it becomes possible for the information processing device 100 to perform the authoring having a range broader than in the related art. In addition, the information processing device 100 is able to display the set AR content.

In this way, the information processing device 100 extracts a predetermined shape from the acquired captured image and receives inputting of the identification information and specification of a position on the captured image screen. In addition, the information processing device 100 causes the storage unit 120 to store therein a positional relationship between an extraction position of the predetermined shape and the specified position while associating the positional relationship with the input identification information. In addition, upon extracting, based on the AR marker having a predetermined shape, identification information, the information processing device 100 displays an AR content corresponding to the identification information, in accordance with the positional relationship stored in the storage unit 120. As a result, it is possible to set the AR content even at a distance at which it is difficult to recognize the AR marker.

Regarding specification of a position, the information processing device 100 receives specification of a position with a side of an AR marker as a reference value. As a result, it is possible to easily arrange an AR content at a relative position based on the corresponding AR marker.

In addition, the information processing device 100 receives, as inputting of identification information, the identification information most recently extracted based on an AR marker. As a result, it is possible to easily receive the inputting of the identification information.

In addition, in the information processing device 100, a predetermined shape is a shape from which the size and inclination of the shape are able to be measured or calculated. As a result, it is possible to display an AR content corresponding to the image-capturing direction of an AR marker.

In addition, the information processing device 100 extracts a predetermined shape from an acquired captured image and receives inputting of identification information. In addition, upon receiving specification of a position at which an AR content is to be arranged on a captured image screen, the information processing device 100 causes the storage unit 120 to store therein a positional relationship between an extraction position of the predetermined shape and the specified position while associating the positional relationship with the input identification information. In addition, upon extracting, based on an AR marker having a predetermined shape, identification information, the information processing device 100 displays an AR content corresponding to the identification information, in accordance with the positional relationship stored in the storage unit 120. As a result, it is possible to set the AR content even at a distance at which it is difficult to recognize the AR marker.

### Second Embodiment

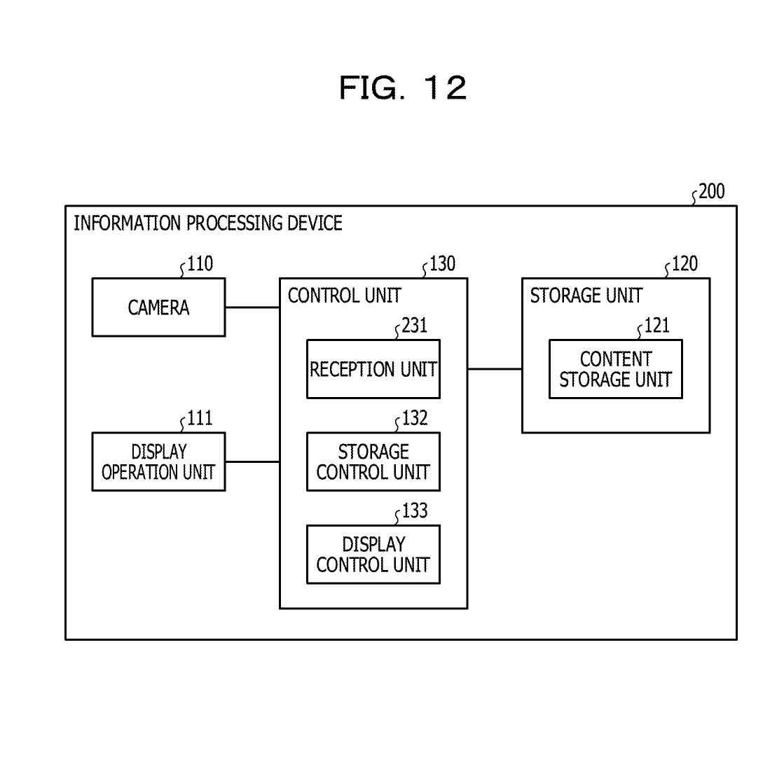

While, in the above-mentioned first embodiment, the authoring is implemented after a marker ID serving as the identification information is received, a marker ID may be received after the authoring is implemented, and an embodiment in this case will be described as a second embodiment. FIG. 12 is a block diagram illustrating an example of a configuration of an information processing device of the second embodiment. Note that the same symbol is assigned to the same configuration as that of the information processing device 100 of the first embodiment, thereby omitting the redundant descriptions of a configuration and an operation thereof.

An information processing device 200 of the second embodiment includes a reception unit 231 in place of the reception unit 131 in the information processing device 100 of the first embodiment.

If the display operation unit 111 inputs operation information to the effect that authoring is to be initiated, the reception unit 231 acquires a captured image from the camera 110 and outputs the stop signal to the camera 110. At this time, the reception unit 231 causes the display operation unit 111 to display the acquired captured image. The reception unit 231 scans the acquired captured image and determines whether or not one or more AR marker candidates exist. In a case where no AR marker candidate exists, the reception unit 231 outputs the start signal to the camera 110.

In a case where one or more AR marker candidates exist, the reception unit 231 extracts shapes of the respective AR marker candidates from the captured image. In other words, the reception unit 231 extracts predetermined shapes from the acquired captured image. The reception unit 231 causes the AR marker candidates, from which shapes thereof on the captured image are extracted, to be highlighted.

On the captured image caused to be displayed by the display operation unit 111, the reception unit 231 starts receiving selection for the AR marker candidates. The reception unit 231 determines whether or not selection is received. In a case where no selection is received, the reception unit 231 waits for reception of selection. In a case where the selection is received, the reception unit 231 implements authoring of a AR content corresponding to the AR marker candidate for which the selection is received.

As the authoring, first the reception unit 231 receives a position on the captured image, at which the corresponding AR content is to be arranged. The reception unit 231 receives specification of a position of the corresponding AR content with a position of, for example, the corresponding AR marker candidate as a reference. If inputting of the corresponding AR content is completed and the authoring is completed, the reception unit 231 starts receiving a marker ID. Note that a user may come close to the corresponding AR marker candidate, thereby causing the reception unit 231 to recognize an AR marker and to receive the corresponding marker ID.

The reception unit 231 determines whether or not a marker ID is received. In a case where no marker ID is received, the reception unit 231 waits for reception of a marker ID. In a case where a marker ID is received, the reception unit 231 outputs, to the storage control unit 132, the received marker ID while associating the received marker ID with the AR content for which the authoring is completed and the position of the AR content. In addition, the reception unit 231 outputs, to the storage control unit 132, the position of the AR marker candidate for which the selection is received.

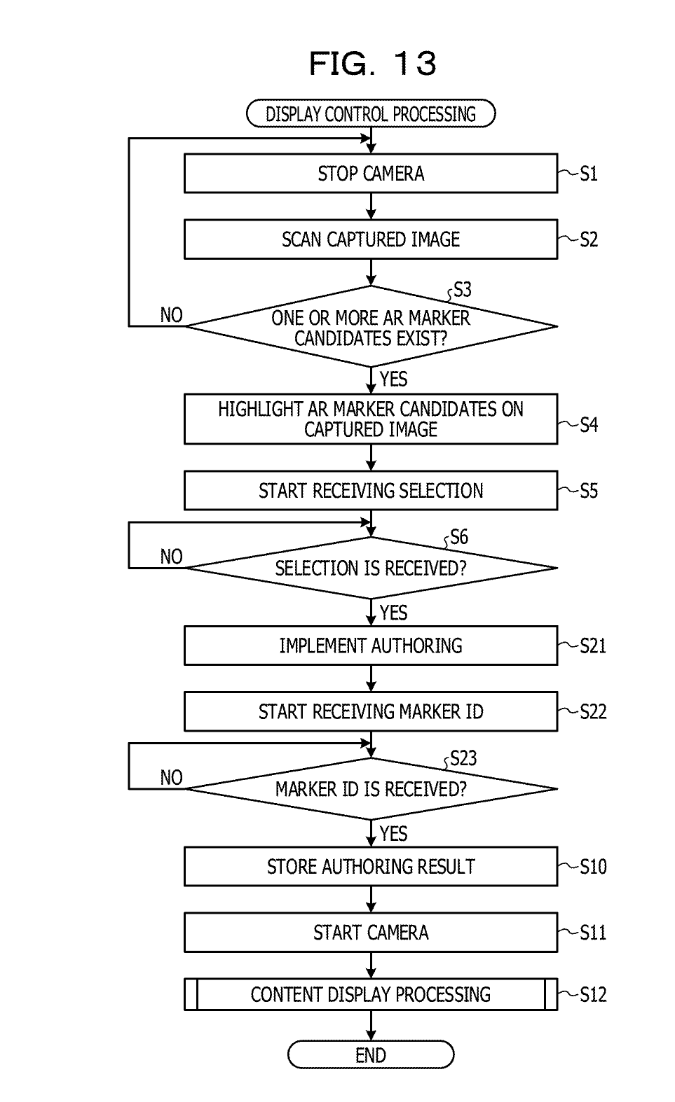

Next, an operation of the information processing device 200 of the second embodiment will be described. Since, in the second embodiment, compared with the display control processing of the first embodiment, processing operations in steps S1 to S6 and S10 to S12 are the same as those of the first embodiment, the descriptions thereof will be omitted. Since in the second embodiment, processing operations in steps S21 to S23 are performed in place of those in steps S7 to S9 in the first embodiment, steps S21 to S23 will be described. FIG. 13 is a flowchart illustrating an example of display control processing of the second embodiment.

In a case where selection is received (step S6: affirmative), the reception unit 231 implements authoring of an AR content corresponding to the AR marker candidate for which the selection is received (step S21). As the authoring, first the reception unit 231 receives a position on the captured image, at which the corresponding AR content is to be arranged. The reception unit 231 receives specification of a position of the corresponding AR content with a position of, for example, the corresponding AR marker candidate as a reference. If inputting of the corresponding AR content is completed and the authoring is completed, the reception unit 231 starts receiving a marker ID (step S22).

The reception unit 231 determines whether or not a marker ID is received (step S23). In a case where no marker ID is received (step S23: negative), the reception unit 231 repeats the determination in step S23. In a case where a marker ID is received (step S23: affirmative), the reception unit 131 outputs, to the storage control unit 132, the received marker ID while associating the received marker ID with the AR content for which the authoring is completed and the position of the AR content. In addition, the reception unit 231 outputs, to the storage control unit 132, the position of the AR marker candidate for which the selection is received. From this, the information processing device 200 is able to set the AR content even at a distance at which it is difficult to recognize an AR marker. In other words, it becomes possible for the information processing device 200 to perform the authoring having a range broader than in the related art. In addition, the information processing device 200 is able to display the set AR content.

### Third Embodiment

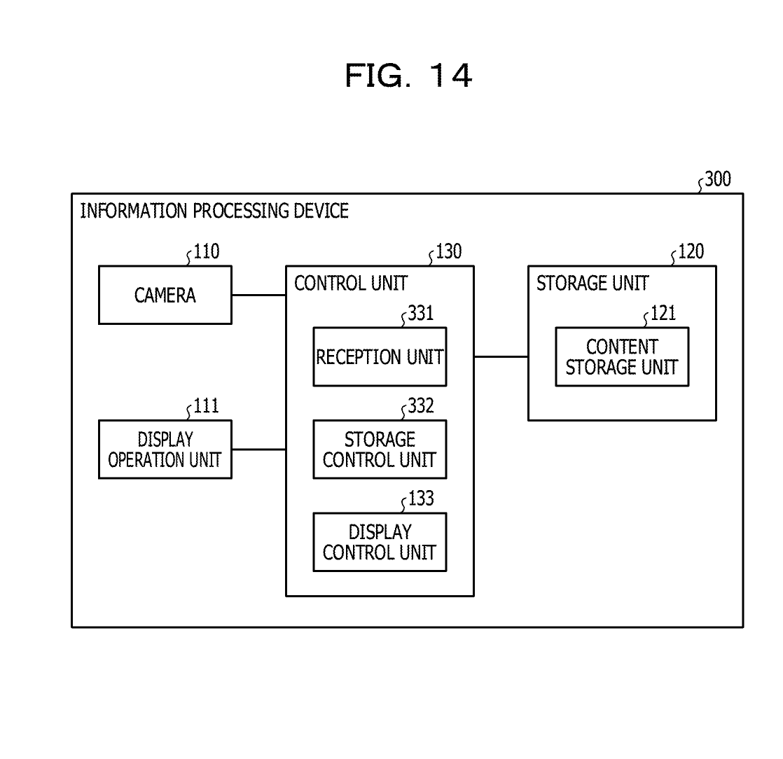

In each of the above-mentioned embodiments, a case where no AR content is associated with the marker ID of an AR marker before authoring is described as an example. In contrast, authoring may be performed on an AR marker whose marker ID is associated with an AR content, and an embodiment in this case will be described as a third embodiment. FIG. 14 is a block diagram illustrating an example of a configuration of an information processing device of the third embodiment. Note that the same symbol is assigned to the same configuration as that of the information processing device 100 of the first embodiment, thereby omitting the redundant descriptions of a configuration and an operation thereof.

An information processing device 300 of the third embodiment includes a reception unit 331 and a storage control unit 332 in place of the reception unit 131 and the storage control unit 132, respectively, in the information processing device 100 of the first embodiment.

If the display operation unit 111 inputs operation information to the effect that authoring is to be initiated, the reception unit 331 acquires a captured image from the camera 110 and outputs the stop signal to the camera 110. At this time, the reception unit 331 causes the display operation unit 111 to display the acquired captured image. The reception unit 331 scans the acquired captured image and determines whether or not one or more AR marker candidates exist. In a case where no AR marker candidate exists, the reception unit 331 outputs the start signal to the camera 110.

In a case where one or more AR marker candidates exist, the reception unit 331 extracts shapes of the respective AR marker candidates from the captured image. In other words, the reception unit 331 extracts predetermined shapes from the acquired captured image. The reception unit 331 causes the AR marker candidates, from which shapes thereof on the captured image are extracted, to be highlighted.

On the captured image caused to be displayed by the display operation unit 111, in other words, a captured image screen, the reception unit 331 starts receiving selection for the AR marker candidates. The reception unit 331 determines whether or not selection is received. In a case where no selection is received, the reception unit 331 waits for reception of selection. In a case where the selection is received, the reception unit 231 starts receiving a marker ID.

The reception unit 331 determines whether or not a marker ID is received. In a case where no marker ID is received, the reception unit 331 waits for reception of a marker ID. In a case where a marker ID is received, the reception unit 331 references the content storage unit 121 and causes an AR content corresponding to the marker ID to be displayed on the captured image screen, based on a positional relationship. Note that regarding an AR content, no information of a positional relationship may exist and in that case, the AR content is displayed at a preliminarily defined position on the captured image screen, such as the upper right of the screen.

The reception unit 331 implements authoring of an AR content corresponding to an AR marker candidate. The reception unit 331 receives a position on the captured image, in other words, the captured image screen, at which the corresponding AR content is to be arranged. In addition, for an already arranged AR content, the reception unit 331 receives specification of a specific arrangement position on the captured image screen. At this time, in a case where the already arranged AR content has information of a positional relationship, the information of a positional relationship is updated, and in a case where the relevant AR content has no information of a positional relationship, information of a positional relationship with the position of the corresponding AR marker candidate is generated. The reception unit 331 outputs, to the storage control unit 332, the position on the captured image, at which the corresponding AR content is to be arranged, while associating the position on the captured image with the corresponding marker ID received for the corresponding AR marker candidate. In addition, the reception unit 331 outputs, to the storage control unit 332, the position of the AR marker candidate for which the selection is received and the input AR content.

In this way, the reception unit 331 extracts a predetermined shape from the acquired captured image and receives inputting of identification information. In addition, the reception unit 331 references the content storage unit 121 and causes an AR content to be displayed on the captured image screen, the AR content being associated with the input identification information and being stored. In other words, the reception unit 331 has functions of both a reception unit and a first display control unit. In addition, at this time, the display control unit 133 has a function of a second display control unit.

If the reception unit 331 inputs the position of the corresponding AR marker candidate, the marker ID, and the position of the corresponding AR content, the storage control unit 332 stores, in the content storage unit 121, a positional relationship between the position of the AR marker candidate and the position of the AR content while associating the positional relationship with the marker ID. In addition, the storage control unit 132 stores, in the content storage unit 121, a newly input AR content while associating the newly input AR content with the corresponding marker ID. At this time, regarding an AR content already stored in the content storage unit 121, the storage control unit 332 updates, with a new positional relationship, the positional relationship of the relevant AR content. In addition, in a case where the relevant AR content has no information of a positional relationship, a new positional relationship is stored while being associated with the relevant AR content. In other words, the storage control unit 332 stores an authoring result in the content storage unit 121. If storing of the authoring result is completed, the storage control unit 332 outputs the start signal to the camera 110.

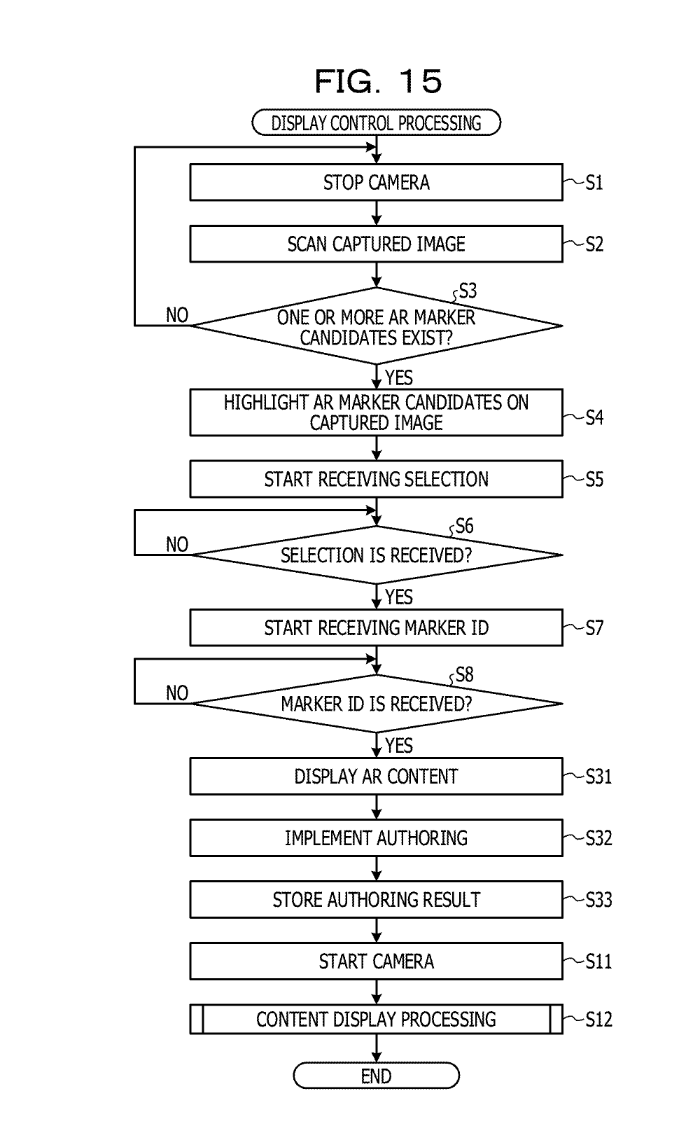

Next, an operation of the information processing device 300 of the third embodiment will be described. Since, in the third embodiment, compared with the display control processing of the first embodiment, processing operations in steps S1 to S8, S11, and S12 are the same as those of the first embodiment, the descriptions thereof will be omitted. Since in the third embodiment, processing operations in steps S31 to S33 are performed in place of those in steps S9 and S10 in the first embodiment, steps S31 to S33 will be described. FIG. 15 is a flowchart illustrating an example of display control processing of the third embodiment.

In a case where a marker ID is received (step S8: affirmative), the reception unit 331 references the content storage unit 121 and causes an AR content corresponding to the marker ID to be displayed on a captured image screen, based on a positional relationship.

The reception unit 331 implements authoring of an AR content corresponding to an AR marker candidate (step S32). The reception unit 331 receives a position on a captured image, at which the corresponding AR content is to be arranged. In addition, for an already arranged AR content, the reception unit 331 receives specification of a specific arrangement position on the captured image screen. The reception unit 331 outputs, to the storage control unit 332, a position on the captured image, at which the corresponding AR content is to be arranged, while associating the position on the captured image with the corresponding marker ID received for the corresponding AR marker candidate. In addition, the reception unit 331 outputs, to the storage control unit 332, the position of the AR marker candidate for which the selection is received and the input AR content.

If the reception unit 331 inputs the position of the corresponding AR marker candidate, the marker ID, and the position of the corresponding AR content, the storage control unit 332 stores, in the content storage unit 121, a positional relationship between the position of the AR marker candidate and the position of the AR content while associating the positional relationship with the marker ID. In addition, the storage control unit 132 stores, in the content storage unit 121, a newly input AR content while associating the newly input AR content with the corresponding marker ID. In other words, the storage control unit 332 stores an authoring result in the content storage unit 121 (step S33). From this, the information processing device 300 is able to update and set the AR content even at a distance at which it is difficult to recognize an AR marker. In other words, it becomes possible for the information processing device 300 to perform the authoring having a range broader than in the related art. In addition, the information processing device 300 is able to display the set AR content.

In this way, the information processing device 300 extracts a predetermined shape from the acquired captured image and receives inputting of identification information. In addition, the information processing device 300 references a storage content of the storage unit 121 storing therein AR contents while associating the AR contents with identification information and causes an AR content to be displayed on the captured image screen, the AR content being associated with the input identification information and being stored. In addition, upon receiving, for the displayed AR content, specification of a specific arrangement position on the captured image screen, the information processing device 300 causes the storage unit 120 to store therein a positional relationship between the extraction position of the predetermined shape and the specified specific arrangement position while associating the positional relationship with the input identification information. In addition, upon extracting, based on an AR marker having the predetermined shape, identification information, the information processing device 300 displays an AR content corresponding to the identification information, in accordance with the corresponding positional relationship stored in the storage unit 120. As a result, it is possible to set the AR content even at a distance at which it is difficult to recognize the AR marker.

Note that while, in each of the above-mentioned embodiments, an AR marker is used as a marker for associating an AR content, there is no limitation thereto. For example, a bar code, a QR code (registered trademark), feature extraction based on image recognition, and so forth, which are each able to recognize a target object, are available as the marker.

In addition, while, in each of the above-mentioned embodiments, an image captured by the camera 110 is defined as a target of processing, there is no limitation thereto. For example, a captured image, which is preliminarily image-captured by another camera and which includes AR marker candidates stored in a storage medium, may be defined as a target of processing.

In addition, individual illustrated configuration elements of individual units do not have to be physically configured as illustrated in drawings. In other words, a specific embodiment of the distribution or integration of the individual units is not limited to one of embodiments illustrated in drawings, and all or some of the individual units may be configured by being functionally or physically integrated or distributed in arbitrary units in accordance with various loads, various statuses of use, and so forth. For example, the reception unit 131 and the storage control unit 132 may be integrated. In addition, the individual processing operations illustrated in drawings are not limited to the above-mentioned orders, may be simultaneously implemented insofar as contents of processing operations do not contradict one another, and may be implemented by changing the orders thereof.

Furthermore, all or arbitrary part of various kinds of processing functions performed in each of devices may be performed on a CPU (or a microcomputer such as an MPU or a micro controller unit (MCU)). It goes without saying that all or arbitrary part of various kinds of processing functions may be performed on a program analyzed and performed in the CPU (or the microcomputer such as the MPU or the MCU) or may be performed on hardware based on hard-wired logic.

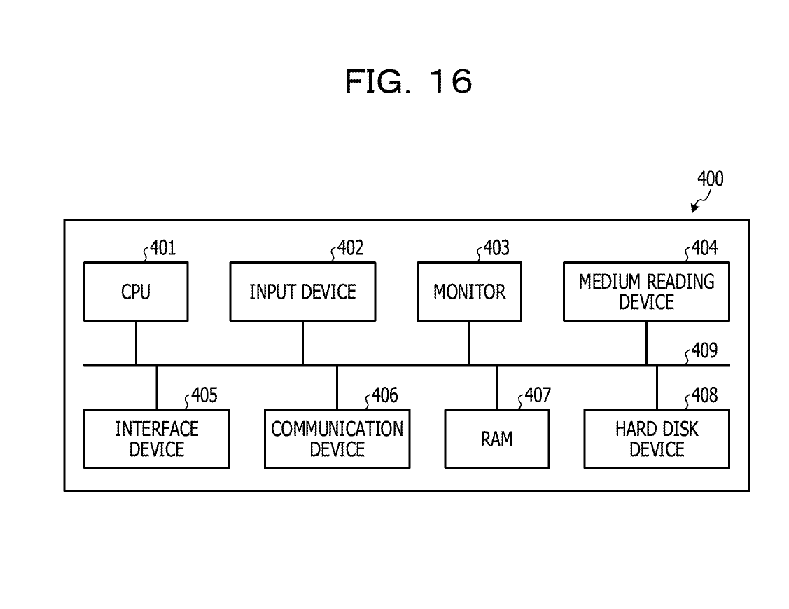

By the way, various kinds of processing described in each of the above-mentioned embodiments may be realized by causing a computer to execute a preliminarily prepared program. Therefore, in what follows, an example of a computer to execute a program having the same functions as those of each of the above-mentioned embodiments will be described. FIG. 16 is a diagram illustrating an example of a computer to execute a display control program.

As illustrated in FIG. 16, a computer 400 includes a CPU 401 to perform various kinds of arithmetic processing operations, an input device 402 to receive data inputs, and a monitor 403. In addition, the computer 400 includes a medium reading device 404 to read programs and so forth from a storage medium, an interface device 405 for being coupled to various kinds of devices, and a communication device 406 for being coupled to another information processing device or the like by using a wired line or wireless. In addition, the computer 400 includes a RAM 407 to temporarily store therein various kinds of information, and a hard disk device 408. In addition, the individual devices 401 to 408 are coupled to a bus 409.

In the hard disk device 408, a display control program having the same functions as those of the individual processing units of the reception unit 131, 231, or 331, the storage control unit 132 or 332, and the display control unit 133, illustrated in FIG. 1, FIG. 12, or FIG. 14. In addition, in the hard disk device 408, various kinds of data for realizing the content storage unit 121 and the display control program are stored.

The input device 402 receives, from a user of the computer 400, inputting of various kinds of information such as, for example, operation information. The monitor 403 displays, for the user of the computer 400, various kinds of screens such as, for example, captured image screens. The camera 110 is coupled to the interface device 405, for example. The communication device 406 is coupled to, for example, a network, not illustrated, and exchanges various kinds of information with another information processing device.

The CPU 401 reads individual programs stored in the hard disk device 408 and deploys and executes the individual programs in the RAM 407, thereby performing various kinds of processing. In addition, these programs are able to cause the computer 400 to function as the reception unit 131, 231, or 331, the storage control unit 132 or 332, and the display control unit 133 illustrated in FIG. 1, FIG. 12, or FIG. 14.

Note that the above-mentioned display control program does not have to be stored in the hard disk device 408. The computer 400 may read and execute, for example, a program stored in a storage medium readable by the computer 400. The storage medium readable by the computer 400 corresponds to, for example, a portable recording medium such as a CD-ROM, a DVD disk, or a universal serial bus (USB) memory, a semiconductor memory such as a flash memory, a hard disk drive, or the like. In addition, the display control program may be stored in advance in a device coupled to a public line, the Internet, a LAN, and so forth, and the computer 400 may read, from these, and execute the display control program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
circuitry configured to:
acquire a first image captured by an imaging device,
extract, from the first image, a plurality of candidate areas each including an object having a shape corresponding to a shape of a marker to be used for augmented reality,
control a display to display a first composite image that applies a predetermined graphical effect on the candidate areas in the first image,
receive selection of a first area of the candidate areas from among the candidate areas,
acquire identification information corresponding to a first marker included in the first area from a source other than the first image,
receive an input corresponding to a first position on the first image as an arrangement position of content to be virtually arranged with reference to the first marker,
convert the first position into positional information in a coordinate system corresponding to the first area, and
store, in a memory, the positional information, the identification information, and the content in association with one another.

2. The information processing system of claim 1, wherein the circuitry is configured to:
acquire a second image captured by the imaging device at a time before the first image is captured, and
extract the identification information corresponding to the first marker from the second image.

3. The information processing system of claim 1, wherein the circuitry is configured to receive a user input including the identification information corresponding to the first marker.

4. The information processing system of claim 1, wherein the circuitry is configured to:
acquire a second image captured by the imaging device at a time after the first image is captured, and
extract the identification information corresponding to the first marker from the second image.

5. The information processing system of claim 1, further comprising:
a user interface configured to receive the input by a user selecting the first position on the first image as the arrangement position of the content to be virtually arranged with reference to the first marker.

6. The information processing system of claim 5, wherein the user interface is configured to receive the input corresponding to the content to be virtually arranged with reference to the first marker.

7. The information processing system of claim 1, wherein the circuitry is configured to:
acquire a second image captured by the imaging device at a time after the first image is captured,
extract identification information corresponding to a marker included in the second image, and
control the display to display a second composite image based on the positional information, the identification information, and the content when it is determined that the extracted identification information matches the identification information corresponding to the first marker.

8. The information processing system of claim 1, wherein the circuitry is configured to convert, into the positional information in the coordinate system corresponding to the first area, a distance between the first position and the first area, based on a length of a side of the first area.

9. The information processing system of claim 1, wherein the shape is a shape from which a positional relationship between the imaging device and the marker is able to be estimated.

10. The information processing system of claim 1, wherein the content is an augmented reality content associated with the first marker.

11. The information processing system of claim 1, wherein the information processing system is a mobile terminal including the circuitry.

12. The information processing system of claim 1, further comprising:
a first mobile terminal including the circuitry; and
a second mobile terminal comprising second circuitry configured to:
acquire a second image captured by the imaging device at a time after the first image is captured,
extract identification information corresponding to a marker included in the second image, and
control another display to display a second composite image based on the positional information, the identification information, and the content when it is determined that the extracted identification information matches the identification information corresponding to the first marker.

13. A method executed by a computer, the method comprising:
acquiring a first image captured by an imaging device;
extracting, from the first image, a plurality of candidate areas having a shape corresponding to a shape of a marker used for augmented reality;
controlling a display to display a first composite image including the first image and graphical effects superimposed on the candidate areas;
receiving a user input selecting a first area of the candidate areas;
acquiring, from a source other than the first image, identification information corresponding to a first marker included in the first area;
receiving an input corresponding to a first position on the first image as an arrangement position of content to be virtually arranged with reference to the first marker; and
storing, in memory, positional information corresponding to the first position, the identification information, and the content in association with one another.

14. The method of claim 13, further comprising:
acquiring a second image captured by the imaging device at a time before the first image is captured; and
extracting the identification information corresponding to the first marker from the second image.

15. The method of claim 13, further comprising:
receiving a user input including the identification information corresponding to the first marker.

16. The method of claim 13, further comprising:
acquiring a second image captured by the imaging device at a time after the first image is captured; and
extracting the identification information corresponding to the first marker from the second image.

17. The method of claim 13, further comprising:
acquiring a second image captured by the imaging device at a time after the first image is captured;
extracting identification information corresponding to a marker included in the second image; and
controlling the display to display a second composite image based on the positional information, the identification information, and the content when it is determined that the extracted identification information matches the identification information corresponding to the first marker.

18. The method of claim 13, further comprising:
converting, into the positional information in a coordinate system corresponding to the first area, a distance between the first position and the first area, based on a length of a side of the first area.

19. The method of claim 13, wherein the shape is a shape from which a positional relationship between the imaging device and the marker is able to be estimated.

20. A non-transitory computer readable medium storing a computer program causing a computer to execute a procedure, the process comprising:
acquiring a first image captured by an imaging device;
extracting, from the first image, a plurality of candidate areas having a shape corresponding to a shape of a marker used for augmented reality;
controlling a display to display a first composite image including the first image and graphical effects superimposed on the candidate areas;
receiving a user input selecting a first area of the candidate areas;
acquiring, from a source other than the first image, identification information corresponding to a first marker included in the first area;
receiving an input corresponding to a first position on the first image as an arrangement position of content to be virtually arranged with reference to the first marker; and
storing, in memory, positional information corresponding to the first position, the identification information, and the content in association with one another.
